(19) United States
(12) Patent Application Publication
(10) Pub. No.: US 2015/0136182 A1
(43) Pub. Date: May 21, 2015

(54) CONTINUOUS-TYPE APPARATUS FOR SURFACE TREATMENT OF WORKPIECES

(71) Applicant: Round Elegant Enterprise Co., Ltd., Changhua City (TW)

(72) Inventor: Yen-Yu CHEN, Changhua City (TW)

(73) Assignee: Round Elegant Enterprise Co., Ltd., Changhua City (TW)

(21) Appl. No.: 14/086,272

(22) Filed: Nov. 21, 2013

(51) Int. Cl. B08B 3/04

(52) U.S. Cl. CPC B08B 3/041
USPC 134/60

(57) ABSTRACT

Disclosed is a continuous type apparatus for surface treatment of workpieces, comprising at least a surface treating bath, a rinsing bath installed on a lifting stage in a production line, a transfer all assembly, and a plurality of water storage tanks out of the production line. The transfer rail assembly passes through the surface treating bath and the rinsing bath where the horizontal transfer height of the transfer rail assembly passing through the rinsing bath is higher than the horizontal transfer height passing through the surface treating bath. The water storage tanks are installed in a non-production line area located outside the transfer path of the transfer rail assembly. The water storage tanks are connected to the rinsing bath by individual pipes. Thereby, the rinsing efficiency can be improved and the lengthy production line can be shortened.

### FIELD OF THE INVENTION

The present invention relates to a surface treatment apparatus for workpieces and more specifically to a continuous-type apparatus for surface treatment of workpieces to improve rinsing efficiency and to shorten production line.

### BACKGROUND OF THE INVENTION

Surface treatment for different sizes of workpieces is a very common manufacture process just to dip workpieces in different surface treating baths such as etching, electrolytic plating, electroless plating, . . . etc. In order to continuously perform surface treatment on workpieces to increase productivity, various continuous-type surface treatment apparatus are disclosed such as a conventional treatment system taught by Francesco in U.S. Pat. No. 6,537,430 B1 entitled “system for galvanic treatment for finishing of pieces, and corresponding method.”

As shown in FIG. 1, a top view of a conventional continuous-type surface treatment apparatus 100 for workpieces is illustrated. From the pointing arrows in FIG. 1, various baths including a first surface treating bath 121 are sequentially arranged along one side of a production line loop between a transfer device 141 and a discharging device 142 with at least two or more of rinsing baths 130 and a second surface treating bath 122 arranged along another side of the production line loop between the transfer device 141 and the discharging device 142. The horizontal heights of the transfer rail passing though all these baths are kept at the same height so that the workpieces transferred by the transfer rail is rinsed by dipping in a plurality of rinsing baths 130. However, the rinsing baths 130 are really long in a production line with poor rinsing efficiency, moreover, the rinsing water in the rinsing baths 130 can not be replaced nor replenished during production.

### SUMMARY OF THE INVENTION

The main purpose of the present invention is to provide a continuous-type apparatus for surface treatment of workpieces to shorten the conventional lengthy production line with improved rinsing efficiency.

Another purpose of the present invention is to provide a continuous-type apparatus for surface treatment of workpieces to replace and replenish rinsing water in a convenient way without affecting the productivity of a production line.

According to the present invention, a continuous-type apparatus for surface treatment of workpieces is revealed, primarily comprising at least a first surface treating bath, a first rinsing bath, a transfer rail assembly, and a plurality of first water storage tanks. The first rinsing bath is installed on a lifting stage in a production line. The transfer rail assembly passes through the first surface treating bath and the first rinsing bath, wherein a first horizontal height of the transfer rail assembly passing through the first rinsing bath is higher than a second horizontal height of the transfer rail assembly passing through the first surface treating bath. The first water storage tanks are installed in a non-production area away from the transfer path of the transfer rail assembly where the first water storage tanks are connected to the first rinsing bath by a plurality of individual first pipes.

### DESCRIPTION OF THE DRAWINGS

FIG. 1 is a top view of a conventional continuous-type surface treatment apparatus.

FIG. 2 is a top view of a continuous-type surface treatment apparatus according to the preferred embodiment of the present invention.

FIG. 3 is a side view of the continuous-type surface treatment apparatus according to the preferred embodiment of the present invention.

FIGS. 4A and 4B are side views of the continuous-type surface treatment apparatus during rinsing processes according to the preferred embodiment of the present invention.

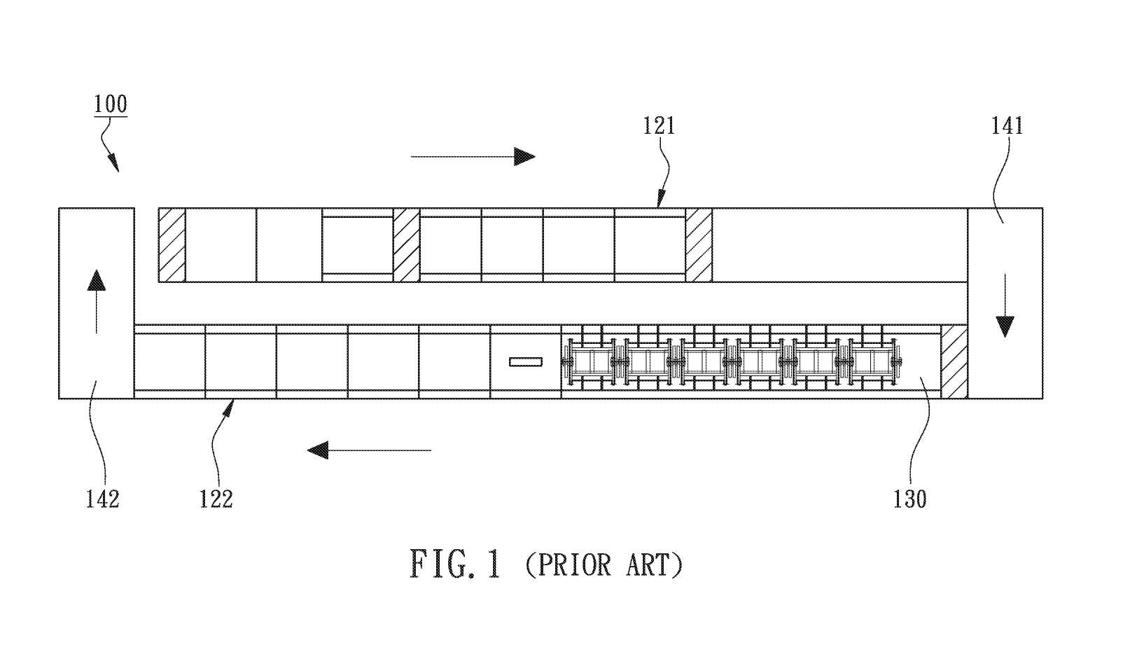

### DETAILED DESCRIPTION OF THE INVENTION

With reference to the attached drawings, the present invention is described by means of the embodiment(s) below where the attached drawings are simplified for illustration purposes only to illustrate the structures or methods of the present invention by describing the relationships between the components and assembly in the present invention. Therefore, the components shown in the figures are not expressed with the actual numbers, actual shapes, actual dimensions, nor with the actual ratio. Some of the dimensions or dimension ratios have been enlarged or simplified to provide a better illustration. The actual numbers, actual shapes, or actual dimension ratios can be selectively designed and disposed and the detail component layouts may be more complicated.

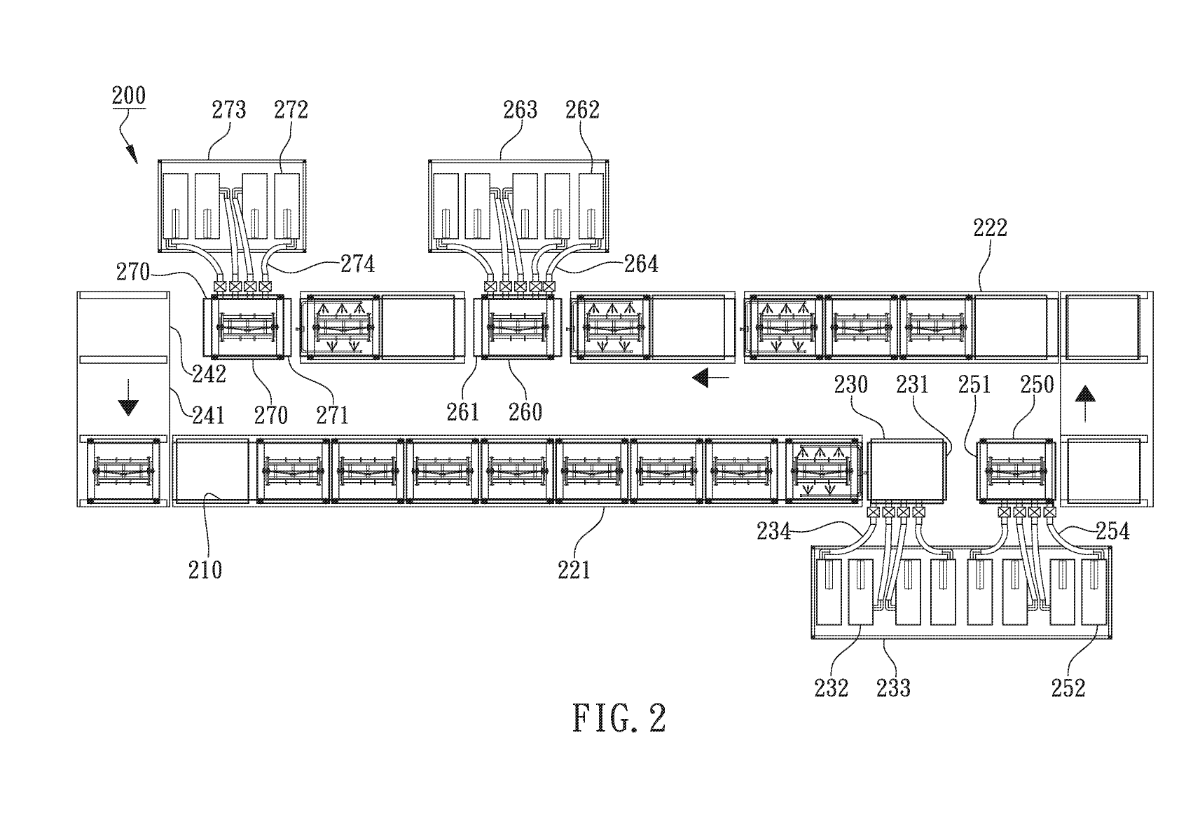

According to the preferred embodiment of the present invention, a continuous-type surface treatment apparatus for workpieces is illustrated in FIG. 2 for a top view and in

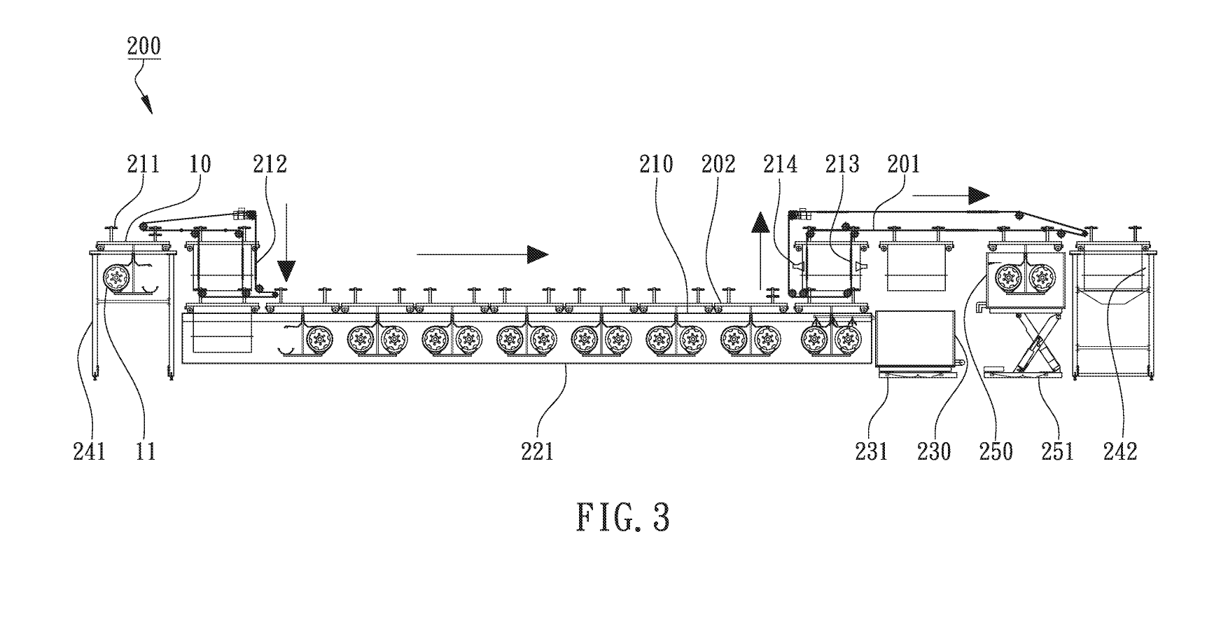

FIG. 3 for a side view. A continuous-type surface apparatus 200 primarily comprises a transfer rail assembly 210, at least a first surface treating bath 221, a first rinsing bath 230, and a plurality of first water storage tanks 232 where the first surface treating bath 221 is to perform various surface treatment processes on workpieces 11 such as etching, plating, etc. and the first rinsing bath 230 is to rinse the treated workpieces 11 to remove surface treating residue.

As shown in FIG. 2 and FIG. 3, the first rinsing bath 230 is installed on a lifting stage 231 in a production line which can be a hydraulic lift platform or a hydraulic spring tube. The transfer rail assembly 210 passes through the first surface treating bath 221 as well as the first rinsing bath 230. As shown in FIG. 3, a first horizontal height 201 of the transfer rail assembly 210 passing through the first rinsing bath 230 is higher than a second horizontal height 202 of the transfer rail assembly 210 passing through the first surface treating bath 221 which can be achieved by an assembly composed of a plurality of transfer rail parts and a plurality of lifting mechanisms. As shown in FIG. 2 again, the first water storage tanks 232 are installed at a non-production area 233 located outside the transfer path of the transfer rail assembly 10 where the first water storage tanks 232 are connected to the first rinsing bath 230 by a plurality of individual first pipes 234. To be more specific, the continuous-type surface treatment apparatus 200 further comprises a second rinsing bath 250 and a plurality of second water storage tanks 252. The second rinsing bath 250 is installed on another lifting stage 251 adjacent to the first rinsing bath 230 where the transfer rail assembly 210 also passes through the second rinsing bath 250. The horizontal height of the transfer rail assembly 210 passing through the second rinsing bath 250 which can be the same as the above mentioned first horizontal transfer height 201 is also higher than the second horizontal height 202 of the transfer rail assembly 210 passing through the first surface treating bath 221. The second water storage tanks 252 are installed at the non-production area 233 and located outside the transfer path of the transfer rail assembly 210 where the second water storage tanks 252 are connected to the second rinsing bath 250 by a plurality of individual second pipes 254.

Again, as shown in FIG. 3, the transfer rail assembly 210 has a plurality of fastening mechanisms 211 such as screw and nut assemblies, or fasteners and cavity assemblies to detachably and temporarily fix a plurality of racks 10 for carrying a plurality of workpieces 11 during surface treating processes, or to fix a tumbling barrel temporarily to carry a plurality of workpieces 11. In the present embodiment, the workpieces 11 are large objects such as automobile wheels or automobile steel body which can be installed on a rack 10. For small workpieces such as small automobile parts or electronic parts, a tumbling barrel can be implemented to carry the plurality of small workpieces.

As shown in FIG. 2 and FIG. 3, the continuous-type surface treatment apparatus 200 for workpieces further comprises a loader 241 and an unloader 242 located at both ends of the transfer rail assembly 210 to independently load proper workpieces 11 on the production line and independently unload the treated workpieces 11 off the production line. The transfer rail assembly 210 further includes a workpiece vertically towering mechanism 212 installed at one side of the first surface treating bath 221 adjacent to the loader 241 and further includes a workpiece lifting mechanism 213 installed at another side of the first rinsing bath 230 adjacent to the first rinsing bath 230. The transfer rail assembly 210 is arranged as a loop so that the loader 241 and the unloader 242 can be connected to each other. Preferably, the continuous-type surface treatment apparatus 200 further comprises a washing nozzle 214 disposed inside the workpiece lifting mechanism 213 to wash away potential residue of treating solution on the workpieces 11.

Therefore, the continuous-type surface treatment apparatus 200 for workpieces of the present invention can reduce the total lengths of the production line as well as the number of rinsing baths. Moreover, washing mechanism can be changed from the conventional dipping to cyclic rinsing to shorten the conventional lengthy production line with improved rinsing efficiency. During production, the rinsing water in the production line can be replaced and replenished by fresh water in the first water storage tank 232 without affecting the productivity.

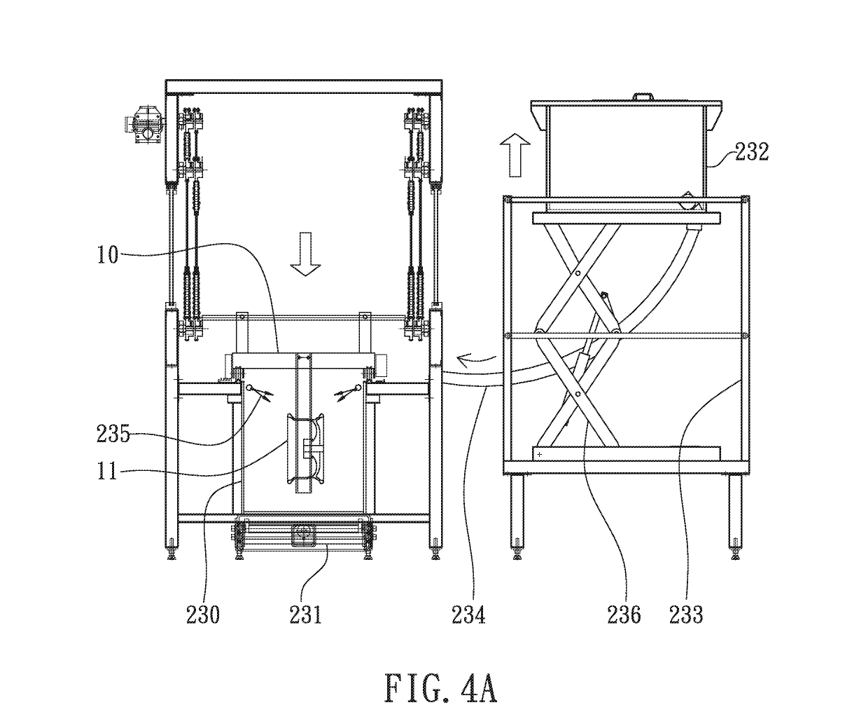

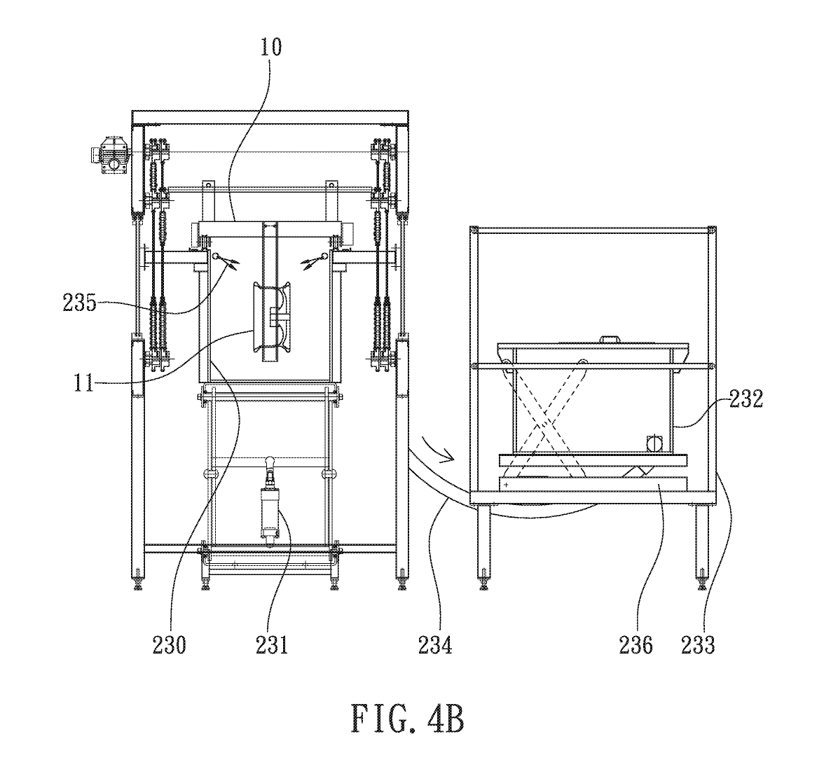

As shown in FIG. 4A and FIG. 4B, the first pipes 234 can be connected to a plurality of spraying heads 235 located on the top edge of the sidewall of the first rinsing bath 230 to rinse, the workpieces 11 inside the first rinsing bath 230 via water level differences without wasting the rinsing water. Preferably, a plurality of non-production line lifting stages 236 are disposed at the non-production line area 233 where the production line lifting stage 231 and one of the non-production line lifting stages 236 are interlaced up and down. The height difference between the production line lifting stage 231 and the non-production line lifting stages 236 is not less than the maximum water depth of the first rinsing bath 230.

As shown in FIG. 4A, during rinsing processes, a specifically assigned first water storage tank 232 is lifted by a corresponding non-production line lifting stage 236. The empty first rinsing bath 230 is kept at a lower horizontal height which may be at the same height as the first surface treating bath 221 so that the height of the first rinsing bath 230 is lower than the specifically assigned first water storage tank 232, therefore, water in the specifically assigned first water storage tank 232 runs through the corresponding first pipe 234 and gush out from the spraying heads 235 to rinse the workpieces 11 inside the first rinsing bath 230 due to water level differences. As shown in FIG. 4B, during rinsing water replacing and replenishing stages after rinsing processes, the first rinsing bath 230 is lifted up by the production line lifting stage 231 located under the first rinsing bath 230 corresponding to the specifically assigned first water storage tank 232 which is repositioned by the non-production line lifting stage 236 so that the horizontal height of the first rinsing bath 230 is higher than the horizontal height of the first water storage tanks 232 without water or with low water level where at least the specifically assigned first water storage tank 232 without water or with low water level is lower than the first rinsing bath 230. Due to the water level difference, water will flow from the first rinsing bath 230 back to the specifically assigned first water storage tank 232 through the individual first pipe 234. Then, another first water storage tank 232 can be assigned to rinse another workpieces 11 in the first rinsing bath 230. Therefore, the rinsing bath 230 on the surface treatment production line can be connected to a plurality of first water storage tanks 232 located at the non-production line area to proceed multiple rinsing processes by different water conditions. Furthermore, lowering the rack 10 can be proceeded after the first rinsing bath 230 has reached high water level or during the replacing and replenishing stage. Lifting the rack 10 can also be proceeded after the first rinsing bath is at the high water level or during the draining stage. It is to say that lifting or lowering the rack and the operation of the first rinsing bath 230 can be performed individually to achieve simplified streamline multi-stage immersion system for rinsing and pre/post treatment in one single bath.

As shown in FIG. 2 again, the continuous-type surface treatment apparatus 200 for workpieces further comprises at least a second surface treating bath 222, a third rinsing bath 260, and a plurality of third water storage tanks 262. The third rinsing bath 260 is installed on another production line lifting stage 261. And the transfer rail assembly 210 also passes through the second surface treating bath 222 and the third rinsing bath 260. Same as the first horizontal transfer height 201 and the second horizontal transfer height 202 mentioned above, the horizontal transfer height of the transfer rail assembly 210 passing through the third rinsing bath 260 is higher than the horizontal transfer height of the transfer rail assembly 210 passing through the second surface treating bath 222. The third water storage tanks 262 are installed at another non-production line area 263 located outside the transfer path of the transfer rail assembly 210. The third water storage tanks 262 are connected to the third rinsing bath 260 by a plurality of individual third pipes 264. The third water storage tanks 262 can be installed, on another non-production line lifting stage.

As shown in FIG. 2 again, the continuous-type surface treatment apparatus 200 for workpieces further comprises at least a fourth rinsing bath 270 and a plurality of fourth water storage tanks 272. The fourth rinsing bath 270 is installed on another production, line lifting stage 271 adjacent to the third rinsing bath 260. The horizontal transfer height of the transfer rail assembly 210 passing through the fourth rinsing bath 270 is higher than the horizontal transfer height of the transfer rail assembly 210 passing through the second surface treating bath 222. The fourth water storage tanks 272 are installed at another non-production line area 273 located outside the transfer path of the transfer rail assembly 210. The fourth water storage tanks 272 are connected to the fourth rinsing bath 270 by a plurality of individual fourth pipe 274. The fourth water storage tanks 272 can be installed on another non-production line lifting stage. Therefore, different surface treating processes can be proceeded in the same production line.

The above description of embodiments of this invention is intended to be illustrative but not limited, Other embodiments of this invention will be obvious to those skilled in the art in view of the above disclosure which still will be covered by and within the scope of the present invention even with any modifications, equivalent variations, and adaptations.

What is claimed is:

1. A continuous-type surface treatment apparatus for workpieces comprising:
at least a surface treating bath;
a first rinsing bath installed on a production line lifting stage;
a transfer rail assembly passing through the first surface treating bath and the first rinsing bath where a first horizontal height of the transfer rail assembly passing through the first rinsing bath is higher than a second horizontal height of the transfer rail assembly passing through the first surface treating bath; and
a plurality of first water storage tanks installed in a non-production line area outside the transfer path of the transfer rail assembly, wherein the first water storage tanks are connected to the first rinsing bath through a plurality of individual first pipes.

2. The continuous-type surface treatment apparatus as claimed in claim 1, wherein the transfer rail assembly includes a plurality of fastening mechanisms to detachably fix a plurality of racks or to fix a tumbling barrier for carrying a plurality of workpieces.

3. The continuous-type surface treatment apparatus as claimed in claim 2, wherein the first pipes are connected to a plurality of spraying heads located on the top edges of the sidewall of the first rinsing bath.

4. The continuous-type surface treatment apparatus as claimed in claim 1, further comprising a loader and an unloader located at both ends of the transfer rail assembly, wherein the transfer rail assembly includes a workpiece vertically lowering mechanism installed at one side of the first surface treating bath adjacent to the loaderand a workpiece lifting mechanism installed at another side of the first surface treating bath adjacent to the first rinsing bath.

5. The continuous-type surface treatment apparatus as claimed in claim 4, further comprising at least a spraying nozzle installed inside the workpiece vertically lifting mechanism.

6. The continuous-type surface treatment apparatus as claimed in claim 4, wherein the transfer rail assembly is arranged as a loop so that the loader and the unloader can be connected together.

7. The continuous-type surface treatment apparatus as claimed in claim 4, wherein a plurality of non-production line lifting stages are installed in the non-production line area, where the production line lifting stage and each one of the non-production line lifting stages are interlaced up and down, wherein the adjustable height difference between the production line lifting stage and the non-production line lifting stages is not less than the maximum water depth of the first rinsing bath.

8. The continuous-type surface treatment apparatus as claimed in claim 1, further comprising:
a second rinsing bath installed on another production line lifting stage adjacent to the first rinsing bath and the transfer rail assembly also passes through the second rinsing bath, where the horizontal height of the transfer rail assembly passing through the second rinsing bath is the first horizontal height which is also higher than the second horizontal height passing through the first surface treating bath; and
a plurality of second water storage tanks, installed in the non-production line area located outside the transfer path of the transfer rail assembly, wherein the second water storage tanks are connected to the second rinsing bath through a plurality of individual second pipes.

9. The continuous-type surface treatment apparatus as claimed in claim 8, further comprising:
at least a second surface treating bath;
a third rinsing bath installed on another production line lifting stage and the transfer rail assembly also passes through the second surface treating bath and the third rinsing bath, wherein a third horizontal height of the transfer rail assembly passing through the third rinsing bath is also higher than a fourth horizontal height passing through the second surface treating bath; and
a plurality of third water storage tanks installed in another non-production line area located outside the transfer path of the transfer rail assembly, wherein the third water storage tanks are connected to the third rinsing bath through a plurality of individual third pipes.

10. The continuous-type surface treatment apparatus as claimed in claim 9, further comprising:
a fourth rinsing bath installed on another production line lifting stage adjacent to the third rinsing bath and the transfer rail assembly also passes through the fourth rinsing bath, wherein the horizontal height of the transfer rail assembly passing through the fourth rinsing bath is the third horizontal height which is also higher than the fourth horizontal height passing through the second surface treating bath; and
a plurality of fourth water storage tanks installed in another non-production line areas located outside the transfer path of the transfer rail assembly, wherein the fourth water storage tanks are connected to the fourth rinsing bath through a plurality of individual fourth pipes.
